(19) United States
(12) Patent Application Publication
(10) Pub. No.: US 2013/0282962 A1
(43) Pub. Date: Oct. 24, 2013

(54) STORAGE CONTROL SYSTEM WITH FLASH CONFIGURATION AND METHOD OF OPERATION THEREOF

(71) Applicant: SMART STORAGE SYSTEMS, INC., Chandler, AZ (US)

(72) Inventors: Bernardo Rub, Sudbury, MA (US); James Fitzpatrick, Sudbury, MA (US); Sheunghee Park, Pleasanton, CA (US); Yi-Ching Wu, Campbell, CA (US); Robert W. Ellis, Phoenix, AZ (US)

(73) Assignee: SMART Storage Systems, Inc., Chandler, AZ (US)

(21) Appl. No.: 13/867,017

(22) Filed: Apr. 19, 2013

Related U.S. Application Data
(60) Provisional application No. 61/636,580, filed on Apr. 20, 2012.

(51) Int. Cl. G06F 12/02; G06F 12/06

(52) U.S. Cl. CPC G06F 12/0246; G06F 12/0646
USPC 711/103; 711/170

(57) ABSTRACT

A storage control system and method of operation thereof includes: a memory circuit for accessing a configuration category; a configuration module, coupled to the memory circuit, for configuring the memory circuit with the configuration category; and an operation module, coupled to the configuration module, for controlling a performance characteristic of a memory device based on the configuration category.

### CROSS-REFERENCE TO RELATED APPLICATION(S)

This application claims the benefit of U.S. Provisional Patent Application Ser. No. 61/636,580 filed Apr. 20, 2012, and the subject matter thereof is incorporated herein by reference thereto.

### TECHNICAL FIELD

The present invention relates generally to a storage control system, and more particularly to a system for flash configuration.

### BACKGROUND ART

Memory devices are typically provided as internal, semiconductor, integrated circuits in computers or other electronic devices. There are many different types of memory including random-access memory (RAM), read only memory (ROM), dynamic random access memory (DRAM), synchronous dynamic random access memory (SDRAM), and flash memory.

Flash memory devices have developed into a popular source of non-volatile memory for a wide range of electronic applications. Flash memory devices typically use a one-transistor memory cell that allows for high memory densities, high reliability, and low power consumption. Changes in threshold voltage of the cells, through programming of charge storage or trapping layers or other physical phenomena, determine the data value of each cell. Common uses for flash memory and other non-volatile memory include personal computers, personal digital assistants (PDAs), digital cameras, digital media players, digital recorders, games, appliances, vehicles, wireless devices, cellular telephones, and removable memory modules, and the uses for non-volatile memory continue to expand.

Flash memory typically utilizes one of two basic architectures that are known as NOR flash and NAND flash. The designation is derived from the logic used to read the devices. In NOR flash architecture, a column of memory cells are coupled in parallel with each memory cell coupled to a bit line. In NAND flash architecture, a column of memory cells are coupled in series with only the first memory cell of the column coupled to a bit line.

NAND flash vendors design and sell chips to meet performance specifications for many applications. However, each application requires slightly different technical requirements and thus a variety of different NAND flash hardware designs are needed to cover the specification demands of the market. The production variations increase time spent in manufacturing and increase overall production costs.

Thus, a need still remains for a storage control system that makes NAND flash hardware designs more uniform by removing the need for a variety of different hardware designs or different build options with a variety of different components. In view of the expanding applications of non-volatile memory into dynamic data management systems, it is increasingly critical that answers be found to these problems. In view of the ever-increasing commercial competitive pressures, along with growing consumer expectations and the diminishing opportunities for meaningful product differentiation in the marketplace, it is critical that answers be found for these problems. Additionally, the need to reduce costs, improve efficiencies and performance, and meet competitive pressures adds an even greater urgency to the critical necessity for finding answers to these problems.

Solutions to these problems have been long sought but prior developments have not taught or suggested any solutions and, thus, solutions to these problems have long eluded those skilled in the art.

### DISCLOSURE OF THE INVENTION

The present invention provides a method of operation of a storage control system including: accessing a configuration category; configuring a memory circuit with the configuration category; and controlling a performance characteristic of a memory device based on the configuration category.

The present invention provides a storage control system, including: a memory circuit for accessing a configuration category; a configuration module, coupled to the memory circuit, for configuring the memory circuit with the configuration category; and an operation module, coupled to the configuration module, for controlling a performance characteristic of a memory device based on the configuration category.

Certain embodiments of the invention have other steps or elements in addition to or in place of those mentioned above. The steps or element will become apparent to those skilled in the art from a reading of the following detailed description when taken with reference to the accompanying drawings.

### BRIEF DESCRIPTION OF THE DRAWINGS

FIG. 1 is an exemplary hardware block diagram of a storage control system in an embodiment of the present invention.

FIG. 2 is an exemplary process flow diagram of a method of manufacture of a solid-state drive.

FIG. 3 is a process flow diagram of a method of manufacture of the storage control system.

FIG. 4 is a second exemplary hardware block diagram of the storage control system.

FIG. 5 is a detailed view of the memory controller of FIG. 4.

FIG. 6 is a control flow of the memory circuit of FIG. 1.

FIG. 7 is a flow chart of a method of operation of the storage control system in a further embodiment of the present invention.

### BEST MODE FOR CARRYING OUT THE INVENTION

The following embodiments are described in sufficient detail to enable those skilled in the art to make and use the invention. It is to be understood that other embodiments would be evident based on the present disclosure, and that system, process, or mechanical changes may be made without departing from the scope of the present invention.

In the following description, numerous specific details are given to provide a thorough understanding of the invention. However, it will be apparent that the invention may be practiced without these specific details. In order to avoid obscuring the present invention, some well-known circuits, system configurations, and process steps are not disclosed in detail.

The drawings showing embodiments of the system are semi-diagrammatic and not to scale and, particularly, some of the dimensions are for the clarity of presentation and are shown exaggerated in the drawing FIGs. Similarly, although the views in the drawings for ease of description generally show similar orientations, this depiction in the FIGs. is arbitrary for the most part. Generally, the invention can be operated in any orientation.

The same numbers are used in all the drawing FIGs. to relate to the same elements. The embodiments have been numbered first embodiment, second embodiment, etc. as a matter of descriptive convenience and are not intended to have any other significance or provide limitations for the present invention.

The term “module” referred to herein can include firmware, or hardware running software, or a combination thereof in the present invention in accordance with the context in which the term is used. For example, the software being run by hardware can be machine code, firmware, embedded code, and application software. Also for example, the hardware can be circuitry, processor, computer, integrated circuit, integrated circuit cores, a pressure sensor, an inertial sensor, a microelectromechanical system (MEMS), passive devices, or a combination thereof.

NAND flash vendors design and sell chips to meet performance specifications that are deemed common to many industries and applications. Cellular phones, compact flash memory sticks, digital cameras and solid state drives all use NAND flash with common designs, yet each application has slightly different technical requirements. Flash vendors design their NAND flash chips to meet the technical specifications that satisfy the largest possible market with a single design.

For solid state drives, SSDs, there are only a few possible practical varieties of NAND that can be integrated into product, yet customers of SSDs have substantially varying needs that are not well satisfied by the very limited number of NAND flash designs. In order to satisfy the needs of the different segments of the SSD market, drive design companies sell SSDs that exceed the requirements of markets with overly expensive components.

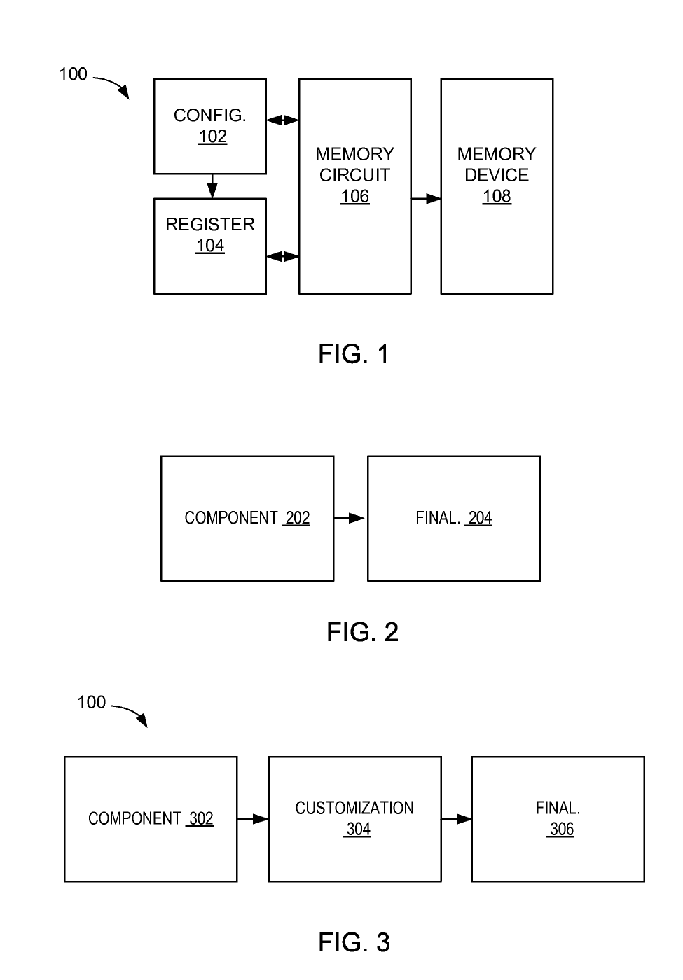

Referring now to FIG. 1, therein is shown an exemplary hardware block diagram of a storage control system 100 in an embodiment of the present invention. The storage control system can be an electronic system, such as a computer system, a non-volatile computer storage device, memory component, or a storage subsystem of an electronic system.

The hardware block diagram can include a configuration memory 102, a volatile register 104, a memory circuit 106, and a memory device 108. For illustrative purposes, the exemplary hardware block diagram can show an internal architecture of a NAND circuit device.

The configuration memory 102 is a non-volatile memory, which can include a read-only memory (ROM), an erasable programmable read-only memory (EPROM), or an electrically erasable programmable read-only memory (EEPROM). The configuration memory 102 can include information, such as firmware, for controlling the operations of the program, erase, and read circuits of the storage control system 100.

The volatile register 104 holds parameters used to define how program, erase, and read circuits are configured. For example, during a power up of the storage control system 100, register information can be loaded into the volatile register 104. The information stored in the volatile register 104 is used to configure the program, erase, and read operations on memory cells of the memory device 108.

The memory circuit 106 can include configurable circuits for programming, erasing, and reading the memory cells of the memory device 108. The memory circuit 106 can include a control unit, a memory controller, or a flash controller for executing program, erase, and read operations on the memory cells.

The memory circuit 106 can be implemented in a number of different manners. For example, the memory circuit 106 can be a processor, an embedded processor, a microprocessor, a hardware control logic, a hardware finite state machine (FSM), or a combination thereof. The memory circuit 106 can use the specific parameters held in the volatile register 104 to define programming, erasing, and reading operations to the memory device 108.

The memory device 108 is non-volatile memory for storing information. For example, the memory device 108 can include NAND flash chips with cells used of storing data.

Referring now to FIG. 2, there is shown an exemplary process flow diagram of a method of manufacture of a solid-state drive. The method includes a component step 202 and a finalization step 204.

The component step 202 includes installing components of the storage control system 100 onto a circuit board including die, chips, devices, and components. For example, NAND flash chips, die, ROM, and other standard components can be installed on the circuit board.

The finalization step 204 includes completing the manufacture and testing of the SDD. For example, the circuit board and components of the NAND device can be encapsulated and packaged based on design needs of customers and end users. Testing can include a burn-in process and a bring-up process. The components of the storage control system 100 can be exercised prior to being placed in service for checking for reliability under stress.

During the manufacture of NAND flash chips, semiconductor circuits are constructed on a large wafer using photolithography, and deposition processes. While the intent is to make each circuit on the wafer uniform in character, some variations occur. To compensate for these variations and imperfections in the fabrication process, each die is electrically characterized and a personalized register configuration is stored in its ROM, such as the configuration memory 102 of FIG. 1.

The configuration of each die is adjusted to produce uniform operating properties that meet a predetermined operating specification for the collection of die. The die are then packaged and sold to digital camera companies, cellar phone companies, SSD companies, and others for integration into end products. The specific definitions of the register configuration define the speed of programming, the number of program and erase cycles that can be applied to the NAND flash, and the data retention qualities of the flash.

Customers of solid state disk drives, or SSDs, are concerned with performance specifications such as the transfer rate to and from the drive, the total amount of data that can be written to the drive before the NAND flash wears out, and a duration of the data that remains reliable after the drive is powered off. The characteristics of these SSD properties are ultimately limited by the properties of the nonvolatile memory integrated into the drive, which in turn is governed by the configuration of the registers used on each die.

SSD vendors select NAND flash with specifications that will enable the drive to meet the desired needs of their customers. However, since NAND flash manufacturers sell to a wide variety of customers that have common needs, they make only a small number of different designs. SSD vendors are in turn limited in the variety of different configurations that they can produce.

Referring now to FIG. 3, therein is shown a process flow diagram of a method of manufacture of the storage control system 100. The process flow can include a component step 302, a customization step 304, and a finalization step 306.

The component step 302 includes installing components of the storage control system 100 onto a circuit board including die, chips, devices, and components. The NAND flash chips, die, ROM, and other standard components can be installed on the circuit board. For example, the configuration memory 102 of FIG. 1, the memory circuit 106 of FIG. 1, the memory device 108 of FIG. 1 and the volatile memory for holding the volatile register 104 of FIG. 1 are assembled.

The customization step 304 includes programming or reprogramming the configuration memory 102 or ROM of the storage control system 100. For example, the configuration memory 102 can be customized to meet certain specifications based on the needs of customers. The storage control system 100 can be programmed to include several customized operational configurations that are programmed into the ROM according to required specification of customers and end-users.

If a customer requires a memory system, such as an SSD, with a long data retention capability after power off, the storage control system 100 can be programmed and customized to prioritize these operational parameters into the configuration memory 102. The modified operational parameters can be loaded into the volatile register 104 and used by the memory circuit 106.

The finalization step 306 includes completing the manufacture and testing of the SDD. For example, the circuit board and components of the NAND device can be encapsulated and packaged for the needs of the customer. Testing can include a burn-in process and a bring-up process. The components of the storage control system 100 can be exercised prior to being placed in service for checking for reliability under stress.

It has been discovered that the storage control system 100 with customizations made to the configuration memory 102 can produce a variety of memory products without having to change the design or architecture of a non-volatile storage device, such as a NAND device. The current invention provides a means for a SSD producer to customize low cost flash to meet multiple market segments with the customization step 304 of programming operational categories in the manufacturing process.

It has been discovered that by accessing and updating the volatile configuration register locations in the volatile register 104, significant operational characteristics can be optimized to meet the requirements of a specific customer applications. It has further been discovered that the storage control system 100 can be customized dynamically in order to extend the operational characteristics of non-volatile storage devices. The customizations made to the configuration memory 102 can be performed during manufacturing or in-field.

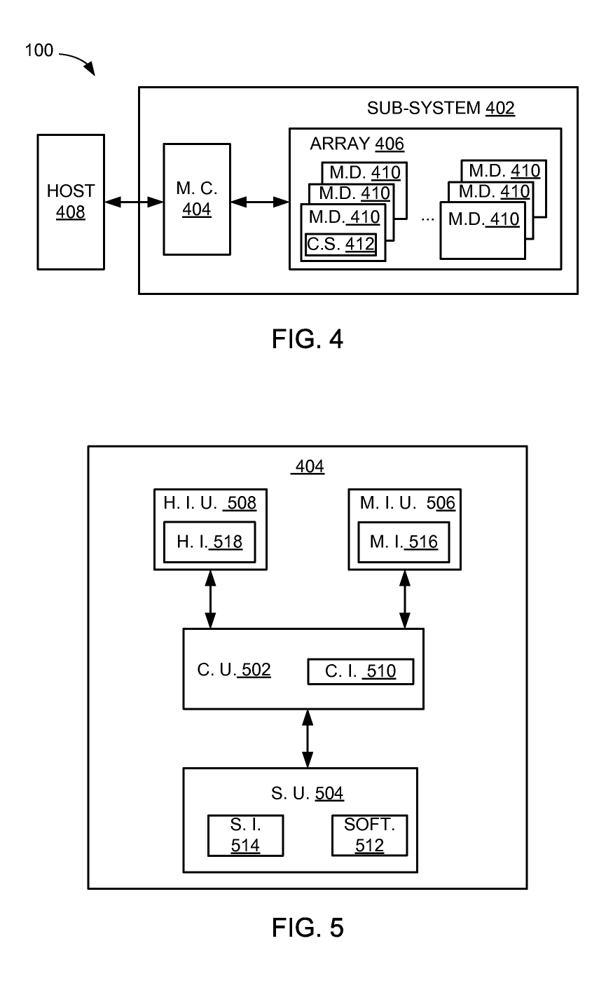

Referring now to FIG. 4, therein shown a second exemplary hardware block diagram of the storage control system 100. The storage control system 100 includes a memory sub-system 402 having a memory controller 404 and a memory array 406. The storage control system 100 includes a host system 408 communicating with the memory sub-system 402.

The memory controller 404 provides data control and management of the memory array 406. The memory controller 404 interfaces with the host system 408 and controls the memory array 406 to transfer data between the host system 408 and the memory array 406.

The memory array 406 includes an array including a memory device 410, which includes flash memory devices or non-volatile memory devices. The memory array 406 can include pages of data or information. The host system 408 can request the memory controller 404 for reading, writing, and erasing data from or to the memory array 406.

The memory device 410 can include chip selects 412, which are defined as control inputs, for enabling the memory device 410. Each of the chip selects 412 can be used to control the operation of one of the memory device 410. When the chip selects 412 are enabled, the memory device 410 are in active state for operation including reading, writing, or recycling. The memory device 410 can be similar to the memory device 108 of FIG. 1.

Referring now to FIG. 5, therein a detailed view of the memory controller 404 of FIG. 4. The memory controller 404 can include a control unit 502, a storage unit 504, a memory interface unit 506, and a host interface unit 508. The control unit 502 can include a control interface 510. The control unit 502 can execute a software 512 stored in the storage unit 504 to provide the intelligence of the memory controller 404.

The control unit 502 can be implemented in a number of different manners. For example, the control unit 502 can be a processor, an embedded processor, a microprocessor, a hardware control logic, a hardware finite state machine (FSM), a digital signal processor (DSP), or a combination thereof. The control unit 502 can perform the same functions and operations as the memory circuit 106 of FIG. 1.

The control interface 510 can be used for communication between the control unit 502 and other functional units in the memory controller 404. The control interface 510 can also be used for communication that is external to the memory controller 404.

The control interface 510 can receive information from the other functional units or from external sources, or can transmit information to the other functional units or to external destinations. The external sources and the external destinations refer to sources and destinations external to the memory controller 404.

The control interface 510 can be implemented in different ways and can include different implementations depending on which functional units or external units are being interfaced with the control interface 510. For example, the control interface 510 can be implemented with a pressure sensor, an inertial sensor, a microelectromechanical system (MEMS), optical circuitry, waveguides, wireless circuitry, wireline circuitry, or a combination thereof.

The storage unit 504 can store the software 512. The storage unit 504 can be a volatile memory, a nonvolatile memory, an internal memory, an external memory, or a combination thereof. For example, the storage unit 504 can be a nonvolatile storage such as non-volatile random access memory (NVRAM), Flash memory, disk storage, or a volatile storage such as static random access memory (SRAM).

The storage unit 504 can include a volatile memory and a nonvolatile memory. A nonvolatile component of the storage unit 504 can be similar to the configuration memory 102 of FIG. 1. A volatile memory component of the storage unit 504 can store the volatile register 104 of FIG. 1.

The storage unit 504 can include a storage interface 514. The storage interface 514 can also be used for communication that is external to the memory controller 404. The storage interface 514 can receive information from the other functional units or from external sources, or can transmit information to the other functional units or to external destinations. The external sources and the external destinations refer to sources and destinations external to the memory controller 404.

The storage interface 514 can include different implementations depending on which functional units or external units are being interfaced with the storage unit 504. The storage interface 514 can be implemented with technologies and techniques similar to the implementation of the control interface 510.

The memory interface unit 506 can enable external communication to and from the memory controller 404. For example, the memory interface unit 506 can permit the memory controller 404 to communicate with the memory array 406 of FIG. 4.

The memory interface unit 506 can include a memory interface 516. The memory interface 516 can be used for communication between the memory interface unit 506 and other functional units in the memory controller 404. The memory interface 516 can receive information from the other functional units or can transmit information to the other functional units.

The memory interface 516 can include different implementations depending on which functional units are being interfaced with the memory interface unit 506. The memory interface 516 can be implemented with technologies and techniques similar to the implementation of the control interface 510.

The host interface unit 508 allows the host system 408 of FIG. 4 to interface and interact with the memory controller 404. The host interface unit 508 can include a host interface 518 to provide communication mechanism between the host interface unit 508 and the host system 408.

The control unit 502 can operate the host interface unit 508 to send control or status information generated by the memory controller 404 to the host system 408. The control unit 502 can also execute the software 512 for the other functions of the memory controller 404. The control unit 502 can further execute the software 512 for interaction with the memory array 406 via the memory interface unit 506.

The functional units in the memory controller 404 can work individually and independently of the other functional units. For illustrative purposes, the memory controller 404 is described by operation of the memory controller 404 with the host system 408 and the memory array 406. It is understood that the memory controller 404, the host system 408, and the memory array 406 can operate any of the modules and functions of the memory controller 404.

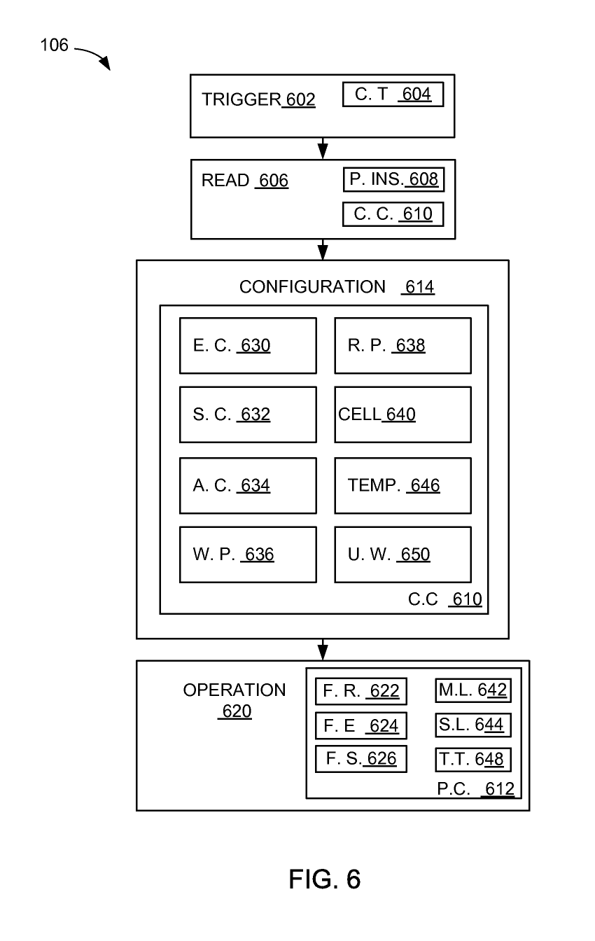

Referring now to FIG. 6, therein is shown a control flow of the memory circuit 106 of FIG. 1. The memory circuit 106 can include a trigger module 602, a read module 606, a configuration module 614, and an operation module 620.

In the control flow, as an example, each module is indicated by a number and successively higher module numbers follow one another. Control flow can pass from one module to the next higher numbered module unless explicitly otherwise indicated.

The memory circuit 106 can execute the trigger module 602, the read module 606, the configuration module 614, and the operation module 620. Further for example, the control unit 502 of FIG. 5 can be coupled to the trigger module 602, the read module 606, the configuration module 614, and the operation module 620 for executing the control flow of the modules.

The trigger module 602 can receive a configuration trigger 604. The configuration trigger 604 is defined as a request or signal for programming a performance or behavior change into the read-only memory (ROM) or firmware of the storage control system 100 of FIG. 1.

The configuration trigger 604 can be sent to the memory circuit 106 during manufacture to customize the storage control system 100 for a specific customer with specific performance requirements. The configuration trigger 604 can also be sent to the memory circuit 106 by an end-user to customize the storage control system 100. The configuration trigger 604 can be used to initiate a global configuration change to the configuration memory 102.

The read module 606 can access a performance instruction 608 stored in the configuration memory 102 of FIG. 1 or the storage unit 504 of FIG. 5. The performance instruction 608 is defined as a set of data or parameters that control the performance of the memory circuit 106 of the control unit 502. The configuration memory 102 can include programmable ROM, such as electrically erasable programmable read-only memory (EEPROM) for storing the performance instruction 608.

The storage control system 100 can include a plurality of the performance instruction 608 for customizing the performance parameters of the storage control system 100. Each of the performance instruction 608 can be associated or tied to one of a plurality of the configuration trigger 604.

The performance instruction 608 controls how the memory circuit 106 or the control unit 502 interacts with and operates the memory device 108 of FIG. 1. The performance instruction 608 can be written into ROM at a manufacturing stage, such as the customization step 304 of FIG. 3 or written into ROM in the field by an end user. For example, the trigger module 602 can program or reprogram the configuration memory 102 with different versions of the performance instruction 608. The performance instruction 608 can include settings, parameters, and instructions for controlling the operations of the memory circuit 106 or the control unit 502. The settings, parameters, and instructions of the performance instruction 608 can be grouped as a configuration category 610.

The configuration category 610 is defined as a mode of operation for the memory circuit 106 to categorize performance settings, parameters, constraints, configurations, and instructions that control how the memory circuit 106 operates the memory device 108. The configuration category 610 can be loaded into the volatile register 104 of FIG. 1 for controlling the writing, erasing, and reading functions of the memory circuit 106 or the control unit 502. For example, the configuration category 610 can provide constraints, settings, limitations, configurations, and parameters that determine the memory circuit 106 control over a performance characteristic 612 of the memory device 108. The performance characteristic 612 will be explained in further detail below.

The storage control system 100 can include a variety of the configuration category 610 and each of the configuration category 610 can be tied to a specific set of the performance instruction 608. The configuration category 610 determines how the memory circuit 106 or the control unit 502 operates and interacts with the memory device 108, such as controlling the speed of reading, writing, and erasing of information.

For example, one of the configuration category 610 can improve endurance of NAND flash by slowing the program speed of the flash. Further for example, another of the configuration category 610 can prioritize NAND programming speed at the cost of reducing the endurance of the flash chips.

The configuration category 610 can include an endurance category 630, a speed category 632, an archive category 634, a write-priority category 636, a read-priority category 638, a cell-operation category 640, a temperature category 646, and a uniform-wear category 650. Each of the configuration category 610 determines the operating priorities, settings, and specifications of the memory device 108. The various examples of the configuration category 610 will be explained in further detail below.

The configuration module 614 can load data, parameters, and tables associated with the configuration category 610 into the volatile register 104. For example, the configuration module 614 can access and manipulate the volatile register 104 used by the memory circuit 106 or the control unit 502 to perform the operations of the storage control system 100. The configuration module 614 can be coupled to the operation module 620 for executing the configuration category 610.

The operation module 620 determines the memory circuit 106 or the control unit 502 interactions with the memory device 108 based on the configuration category 610 loaded into the volatile register 104. The operation module 620 determines the operations of the memory circuit 106 or the control unit 502 according to the performance constraints and priorities set by the configuration category 610. For example, the configuration category 610 can prioritize the performance characteristic 612 of the memory device 108.

The performance characteristic 612 is defined as a physical attribute associated with the memory device 108, such as the programming speed or a lifespan of the memory device 108. For example, the performance characteristic 612 can include a flash retention 622, a flash endurance 624, and a flash speed 626.

The flash retention 622 is the ability of the memory device 108 to hold an electrical charge after information is written to the memory device 108. The flash retention 622 increases if higher voltages are applied to the memory device 108. However, other types of the performance characteristic 612, such as the flash speed 626 decrease because of the time required to apply higher charges to the memory device 108. By increasing the flash retention 622, the problems associated with read disturb errors are decreased in the memory device 108.

The flash endurance 624 is the total life span of the memory device 108. The memory circuit 106 or the control unit 502 can perform wear leveling operations and reduce erasures of the blocks of the memory device 108 to increase the flash endurance 624.

The flash speed 626 is the speed that the memory circuit 106 or the control unit 502 can program, read, and erase information to the memory device 108. By increasing the flash speed 626, other types of the performance characteristic 612, such as the flash retention 622 and the flash endurance 624 can be reduced by prioritizing speed. For example, the memory circuit 106 or the control unit 502 can use less charge to quickly write information to the memory device 108. The reduced charge in the memory device 108 will reduce the flash retention 622 of the memory device 108.

The configuration category 610 can prioritize or deprioritize each of the examples of the performance characteristic 612. For example, the configuration category 610 includes the endurance category 630. The endurance category 630 prioritizes maximizing the flash endurance 624 over the other attributes of the performance characteristic 612. The endurance category 630 can maximize the life span of the memory device 108 by sacrificing operations that maximize the flash speed 626 and the flash retention 622.

The configuration category 610 includes the speed category 632. The speed category 632 causes the memory circuit 106 or the control unit 502 to prioritize the speed of read, erase, and write operations over maximizing the flash retention 622 and the flash endurance 624.

The configuration category 610 includes the archive category 634. The archive category 634 causes the memory circuit 106 or the control unit 502 to prioritize operations that maximize the flash retention 622 of the memory device 108, while sacrificing the flash endurance 624 and the flash speed 626.

The configuration category 610 includes the write-priority category 636. The write-priority category 636 can cause the memory circuit 106 or the control unit 502 to operate as a data logging device. For example, the operations of the memory circuit 106 or the control unit 502 can prioritize write functions to ninety percent while assigning only ten percent priority for read functions.

The configuration category 610 includes the read-priority category 638. The read-priority category 638 causes the memory circuit 106 or the control unit 502 to operate like a boot drive device. For example, the operations of the memory circuit 106 can prioritize read functions to ninety percent while assigning only ten percent priority for write functions.

The configuration category 610 includes the cell-operation category 640. The cell-operation category 640 allows the memory circuit 106 or the control unit 502 to convert multi-level cells in the memory device 108 to single level cells. For example, multi-level cells, such a triple-level cells (TLC) can be converted to only storing a single bit of information and function in the same way that a single-level cell device would function.

The memory device 108 can operate under a multi-level cell operation 642 while multiple bits of information are stored into a single cell. The memory device 108 can operate under a single level cell operation 644 when a single bit is used to store information into a single cell. The multi-level cell operation 642 and the single level cell operation 644 can be examples of the performance characteristic 612. The memory circuit 106 can change the multi-level cell operation 642 of a memory cell to the single level cell operation 644.

The configuration category 610 includes the temperature category 646. Under the temperature category 646, the memory circuit 106 or the control unit 502 operates the memory device 108 at a target temperature 648, which is a predetermined temperature. The ranges for the target temperature 648 can be extreme low, extreme high, or at a normal operating temperature range. The target temperature 648 can be an example of the performance characteristic 612

The configuration category 610 includes the uniform-wear category 650. The uniform-wear category 650 causes the memory circuit 106 or the control unit 502 to manipulate the flash retention 622 of multiple flash die within the storage control system 100 to be equal. For example, the memory circuit 106 can match the flash retention 622 of the memory device 108 to another of the memory device 108 so that the flash retention 622 of all die in the storage control system 100 are equal.

The performance instruction 608 can also include a method for disabling or destroying the functions of the storage control system 100. For example, the performance instruction 608 can include a disable category, which can be programmed into the configuration memory 102 to prevent any operations of the memory circuit 106 on the memory device 108. Read, write, and erase functions can be disabled as the ROM parameters make read and write operations ineffective. The configuration trigger 604 can be used to disable the functions of the storage control system 100.

The configuration category 610 can also be customized to place specific constraints on the memory circuit 106. For example, the configuration category 610 can be customized to include a constraint for the amount of write operations performed during a twenty four hour period for prolonging the life-span of the storage control system 100.

The configuration category 610 can also be further customized to mix the workload of read and write operations. Instead of using the read-priority category 638, the configuration category 610 can be customized for specific percentages for read and write operations. For example, the read operations of the storage control system 100 can be limited to thirty percent use and the write operations can be set to seventy percent use.

The configuration category 610 can also be change to account for situations including the age of the storage control system 100, periods of non-use, intended industry use, and the total number of power cycles. For example, as the storage control system 100 ages, attributes associated with the performance characteristic 612 of the memory device 108 can deteriorate. The performance instruction 608 can be programed to account for the deterioration of the storage control system 100 based on the performance needs of the consumer.

Further for example, the configuration category 610 can be reprogramed to the archive category 634, if the storage control system 100 will be intended for a long period of non-use or the storage control system 100 will be off for a long duration. The storage control system 100 can also store the total number of power cycles during the life of the device. The configuration category 610 can also be changed based on the number of power cycles as an indicator of the age of the storage control system 100.

The configuration category 610 can also be changed or customized based on the intended industry use of the storage control system 100. For example, if the storage control system 100 is used during extreme environmental conditions, such as desert or military use, the temperature category 646 can be changed.

The configuration category 610 can also be customized based on intended use such as a high volume sequential write use or a high volumes of random write use. For example, if the storage control system 100 is used to store large media files, the flash retention 622 of the memory device 108 can be prioritized. If the intended use of the storage control system 100 is for high volumes of random write use, the flash endurance 624 and wear leveling operations can be prioritized by customizing the configuration category 610.

The configuration category 610 can also be customized based on latent defects discovered in the NAND chips of the memory device 108. For example, latent defects in the NAND chips can affect the performance settings, parameters, constraints, and configurations that are already programed into the performance instruction 608. The performance instruction 608 can be reprogramed to adjust for the latent defects in the NAND chip with a customized version of the configuration category 610. Reprograming the performance instruction 608 allows an end-user the ability to optimize the performance of the storage control system 100 based on unexpected conditions during the lifespan of the device.

It has been discovered that the performance instruction 608 and the configuration category 610 for controlling the memory circuit 106 or the control unit 502 allows the storage control system 100 to be customized to fix a variety of different performance and specification needs of customers. By customizing the memory circuit 106 or the control unit 502 to perform under specific examples of the configuration category 610, the storage control system 100 can serve different markets with a single hardware design.

It has been discovered that the present invention with the performance instruction 608 can create customizable memory devices with customizable specifications from low cost flash. For example, the performance instruction 608 can be written into the ROM of each NAND die to produce a variety of memory products for different market segments.

It have been discovered that the configuration category 610 provides memory devices that are customizable while preventing end users from damaging the storage control system 100 or improper limiting the use and capabilities of the memory device 108 or the memory sub-system 402 of FIG. 4. For example, the configuration category 610 provides an abstraction layer for allowing end user customization without giving the customer the specific hardware specifications of the memory device 108.

It has been discovered that the cell-operation category 640 provides a method for changing the multi-level cell operation 642 of the storage control system 100 to the single level cell operation 644. By storing a single bit in cell memory, the single level cell operation 644 can provide the benefit of increasing the flash retention 622, the flash endurance 624, the flash speed 626, or a combination thereof.

It has been discovered that the method of programming the memory circuit 106 with the temperature category 646 allows the storage control system 100 to be operated at the target temperature 648 without hardware modifications to NAND devices. It has been discovered that the method of programming the memory circuit 106 with the performance instruction 608 having a disable category can modify the configuration memory 102 to make read and write operations unusable.

The storage control system 100 describes the module functions or order as an example. The modules can be partitioned differently. For example, the trigger module 602, the read module 606, the configuration module 614, and the operation module 620 can be implemented as one module or with lesser number of modules. Each of the modules can operate individually and independently of the other modules.

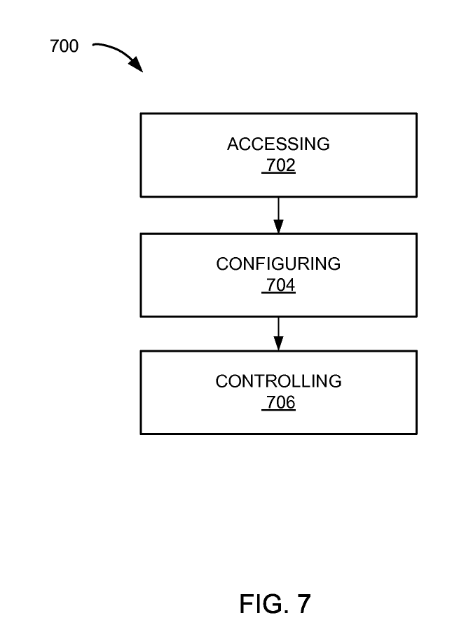

Referring now to FIG. 7, therein is shown a flow chart of a method 700 of operation of the storage control system 100 in a further embodiment of the present invention. The method 700 includes: accessing a configuration category in a block 702; configuring a memory circuit with the configuration category in a block 704; and controlling a performance characteristic of a memory device based on the configuration category in a block 706.

Thus, it has been discovered that the storage control system 100 of the present invention furnishes important and heretofore unknown and unavailable solutions, capabilities, and functional aspects for an electronic system with read disturb management mechanism. The resulting method, process, apparatus, device, product, and/or system is straightforward, cost-effective, uncomplicated, highly versatile, accurate, sensitive, and effective, and can be implemented by adapting known components for ready, efficient, and economical manufacturing, application, and utilization.

Another important aspect of the present invention is that it valuably supports and services the historical trend of reducing costs, simplifying systems, and increasing performance. These and other valuable aspects of the present invention consequently further the state of the technology to at least the next level.

While the invention has been described in conjunction with a specific best mode, it is to be understood that many alternatives, modifications, and variations will be apparent to those skilled in the art in light of the aforegoing description. Accordingly, it is intended to embrace all such alternatives, modifications, and variations that fall within the scope of the included claims. All matters hithertofore set forth herein or shown in the accompanying drawings are to be interpreted in an illustrative and non-limiting sense.

What is claimed is:

1. A method of operation of a storage control system comprising:
accessing a configuration category;
configuring a memory circuit with the configuration category; and
controlling a performance characteristic of a memory device based on the configuration category.

2. The method as claimed in claim 1 wherein controlling the performance characteristic includes manipulating a flash retention, a flash endurance, a flash speed, or a combination thereof

3. The method as claimed in claim 1 wherein accessing the configuration category includes accessing an endurance category for increasing a flash endurance.

4. The method as claimed in claim 1 wherein accessing the configuration category includes accessing a speed category for increasing a flash speed.

5. The method as claimed in claim 1 wherein accessing the configuration category includes accessing an archive category for increasing a flash retention.

6. A method of operation of storage control system comprising:
programming a performance instruction having a configuration category;
operating a volatile register based on the configuration category;
configuring a memory circuit with the configuration category; and
controlling a performance characteristic of the memory device based on the configuration category.

7. The method as claimed in claim 6 wherein:
configuring the memory circuit includes configuring the memory circuit with a cell-operation category; and
controlling the performance characteristic includes changing a multi-level cell operation to a single level cell operation.

8. The method as claimed in claim 6 wherein:
configuring the memory circuit includes configuring the memory circuit with a temperature category; and
controlling the performance characteristic includes operating the memory device at a target temperature.

9. The method as claimed in claim 6 wherein:
configuring the memory circuit includes configuring the memory circuit with a uniform-wear category; and
controlling the performance characteristic includes adjusting a flash endurance of the memory device to equal the flash endurance of another of the memory device.

10. The method as claimed in claim 6 wherein programming the performance instruction includes storing the performance instruction and another of the performance instruction into the configuration memory.

11. A storage control system comprising:
a memory circuit for accessing a configuration category;
a configuration module, coupled to the memory circuit, for configuring the memory circuit with the configuration category; and
an operation module, coupled to the configuration module, for controlling a performance characteristic of a memory device based on the configuration category.

12. The system as claimed in claim 11 wherein the memory circuit is for manipulating a flash retention, a flash endurance, a flash speed, or a combination thereof

13. The system as claimed in claim 11 wherein the memory circuit is for accessing an endurance category for increasing a flash endurance.

14. The system as claimed in claim 11 wherein the memory circuit is for accessing a speed category for increasing a flash speed.

15. The system as claimed in claim 11 wherein the memory circuit is for accessing an archive category for increasing a flash retention.

16. The system as claimed in claim 11 further comprising:
a trigger module, coupled to the operation module, for programming a performance instruction having the configuration category; and
wherein:
the configuration module is for operating a volatile register based on the configuration category.

17. The system as claimed in claim 16 wherein:
the configuration module is for configuring the memory circuit with a cell-operation category; and
the operation module is for changing a multi-level cell operation to a single level cell operation.

18. The system as claimed in claim 16 wherein:
the configuration module is for configuring the memory circuit with a temperature category; and
the operation module is for operating the memory device at a target temperature.

19. The system as claimed in claim 16 wherein:
the configuration module is for configuring the memory circuit with a uniform-wear category; and
the operation module is for adjusting a flash endurance of the memory device to equal the flash endurance of another of the memory device.

20. The system as claimed in claim 16 wherein the trigger module is for storing the performance instruction and another of the performance instruction into the configuration memory.
